(19) United States
(12) Patent Application Publication
(10) Pub. No.: US 2021/0345599 A1
(43) Pub. Date: Nov. 11, 2021

(54) Multiple Species Waterfowl Caller

(71) Applicant: Stephen Ivanoff, Unalakleet, AK (US)

(72) Inventor: Stephen Ivanoff, Unalakleet, AK (US)

(21) Appl. No.: 16/869,813

(22) Filed: May 8, 2020

(51) Int. Cl. A01M 31/00

(52) U.S. Cl. CPC A01M 31/004

(57) ABSTRACT

A multiple species waterfowl caller including a first upper section and a second lower section. The first upper section and the second lower section are cylindrical bodies. The first upper section and the second lower section are capable of being removably coupled together. The second lower section has a first reed placed therein. The first upper section has an air pathway therethrough that allows air to be blown across the reed. The second lower section and the reed are configured to let out a low pitch tone. This call will allow multiple different species to be called with one call.

### BACKGROUND OF THE INVENTION

The present invention relates to a single device that is a multiple species waterfowl caller. More particularly, the present invention provides a single waterfowl bird call that can attract more than one species by making a low call.

Many people enjoy being out in nature. Waterfowl provide a vast amount of enjoyment to people. Whether bird watching or bird hunting people use calls to attract the waterfowl to a desired area. There are many different types of calls and many different sounds that each call can make. These calls can be extremely costly. Further, it can become confusing which call is for which species.

Traditionally, each species requires at least one call. Each waterfowl call is designed to make a very specific and limited set of sounds. This means that an individual could end up purchasing and needing to carry many different calls. These calls could be extremely cumbersome. Calls may not be easy to carry because of the way they need to be stored and protected. In addition, many existing waterfowl calls are ineffective at attracting swans, sandhill cranes, specklebelly goose, whitefront goose, Canadian goose, snow goose, loon, Pacific brant, and cackling goose. As such, getting an effective shot of these species is difficult.

Consequently, there is a need in for an improvement in the art of waterfowl calls. The present invention substantially diverges in design elements from the known art while at the same time solves a problem many people face when using bird calls to bring waterfowl in close for a shot either with a camera or a gun. In this regard the present invention substantially fulfills these needs.

### SUMMARY OF THE INVENTION

The present invention provides a multiple species waterfowl caller wherein the same can be utilized for providing convenience for the user when using a multiple species waterfowl caller. The multiple species waterfowl caller comprises a first upper section and a second lower section. The first upper section is a cylindrical body. The cylindrical body has openings at both ends and a hole therethrough. A first opening is a mouth portion, wherein the first opening will accept air. A second opening is a larger opening, wherein the larger second opening is configured to accept the second lower section. The second lower section has an opening at both ends. The second lower section has a reed sticking upward above a top edge of the second lower section. The lower section and the first reed are configured to make a low pitch sound which can imitate multiple species of waterfowl.

Another object of the multiple species waterfowl caller is to further comprise an airtight seal between the first upper section and the second lower section.

Another object of the multiple species waterfowl caller is to further comprise the second lower section is cylindrical and is tapered toward the second opening.

Another object of the multiple species waterfowl caller is to further comprise the first upper section tapes inward toward the middle of the first upper section.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the multiple species waterfowl caller.

FIG. 2 shows a perspective view of an embodiment of the multiple species waterfowl caller.

### DETAILED DESCRIPTION OF THE INVENTION

Reference is made herein to the attached drawings. Like reference numerals are used throughout the drawings to depict like or similar elements of the multiple species waterfowl caller. For the purposes of presenting a brief and clear description of the present invention, a preferred embodiment will be discussed as used for the multiple species waterfowl caller. The figures are intended for representative purposes only and should not be considered to be limiting in any respect.

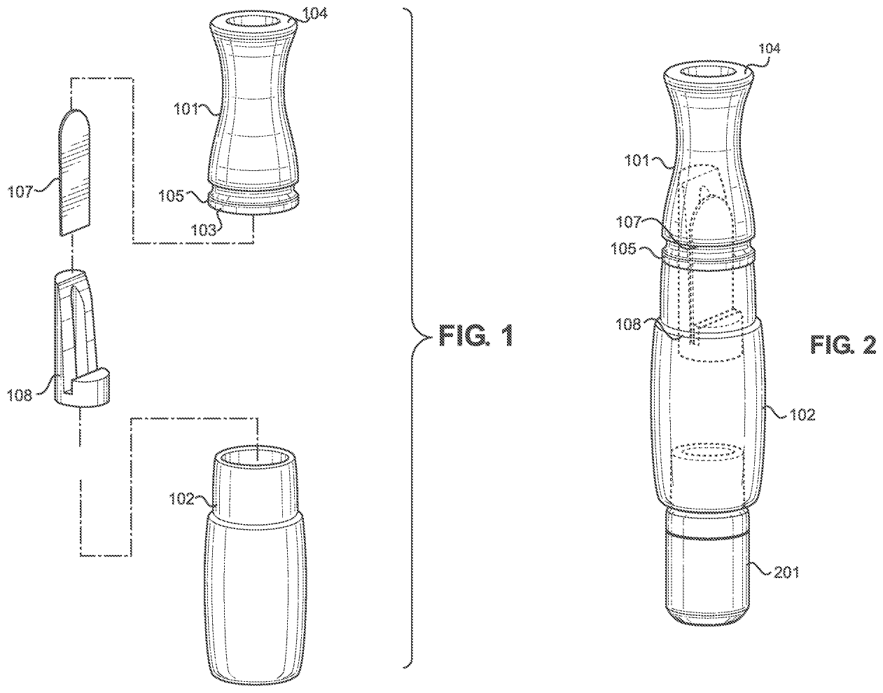

Referring now to FIG. 1, there is shown an exploded view of an embodiment of the multiple species waterfowl caller. The multiple species waterfowl caller is comprised of a top section 101 and a lower section 102. The top section 101 is cylindrical and has a hole 103 located longitudinally therethrough. A mouthpiece 104 is located at one end of the top section 101. The hole 103 widens from the mouthpiece 104 toward a second end of the top section 101. This will allow for the bottom section 102 to be fit into the top section 101. The hole 103 is configured to fictionally fit the bottom section 102 therein. In one embodiment there is a reinforcing ring 105 placed around the second end of the top section 101. In one embodiment the top section 101 has an ergonomic shape. In one embodiment the top section 101 tapers inwards toward the middle of the top section 101 from each end.

In one embodiment the lower section 102 has a conical shape. The cone shape is narrow toward a top end of the lower 102 section and widens toward a second end of the lower section 102. This shape will help to project the sound of the multiple species waterfowl caller. The lower section 102 is sized to frictionally fit partially within the top section 101, as shown in FIG. 2.

The lower section 102 has a sound device 106 located therein. The sound device 106 comprises at least one reed 107. In one embodiment the at least one reed 107 is a wooden reed. In one embodiment the at least one reed 107 is a synthetic reed. The at least one reed 107 is placed within a reed holder 108. The reed holder 108 will pinch the at least one reed 107 against a surface such that air passing over the at least one reed 107 will vibrate the at least one reed 107 causing a sound. In one embodiment the reed holder 108 will further include a shim to hold the reed in place. In one embodiment the reed holder 108 will have a tuning band 109 placed around the at least one reed 107 and the reed holder 108. The tuning band 109 will allow the at least one reed 107 to be tuned by selectively moving the tuning band 109 along a length of the at least one reed 107.

Referring now to FIG. 2, there is shown a perspective view of an embodiment of the multiple species waterfowl caller. In this view the top section 101 and the lower section 102 are fit together. The lower section 102 is configured to fit within the top section 101. The sound device 106 is protruded from the top of the bottom section 102. The sound device will be positioned within the top section 101. The sound device 106 will not protrude into the mouthpiece 104. In some embodiments the top section 101 and the bottom section 102 are not separable.

In the shown embodiment there is a second lower section 201. The second lower section 201 is configured to fit within the first lower section 102. The second lower section will add length to the chamber of the multiple species waterfowl caller. This extended chamber will allow different sounds to be made. By adding or removing the second lower section will allow different sounds to be made without needed a different call.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A multiple species waterfowl caller, comprising:
a top section and a lower section;
wherein the top section is a cylindrical body;
wherein the cylindrical body has a pair of openings at both ends and a channel therethrough;
a first opening of the pair of openings is a mouth portion, wherein the opening will accept air, a second opening of the pair of openings is a larger opening that the first opening, wherein the larger opening is configured to accept the second lower section;
wherein the second lower section has an opening at both ends;
the second lower section has a first reed sticking upward above a top edge of the second lower section;
the second lower section and the first reed are configured to make a low pitch sound which can imitate multiple species of waterfowl.

2) The multiple species waterfowl caller of claim 1, further comprising an airtight seal between the upper section and the lower section when the upper section and the lower section are secured together.

3) The multiple species waterfowl caller of claim 1, wherein the second lower section is cylindrical and is tapered toward the second opening.

4) The multiple species waterfowl caller of claim 1, wherein the first upper section tapers inward toward the middle of the first upper section.

5) A multiple species waterfowl caller, comprising:
A top section and a lower section;
the top section is a cylindrical body, wherein a reinforcement ring is placed around the second end of the top section;
wherein the cylindrical body has a pair of openings at both ends and a channel therethrough;
a first opening of the pair of openings is a mouth portion, wherein the opening will accept air, a second opening of the pair of openings is a larger opening that the first opening, wherein the larger opening is configured to accept the second lower section;
the lower section has an opening at both ends;
the lower section has a reed sticking upward above a top edge of the lower section;
the section and the first reed are configured to make a low pitch sound which can imitate multiple species of waterfowl.

6) The multiple species waterfowl caller of claim 9, further comprising an airtight seal between the upper section and the lower section when the upper section and the lower section are secured together.

7) The multiple species waterfowl caller of claim 9, wherein the second lower section is cylindrical and is tapered toward the second opening.

8) The multiple species waterfowl caller of claim 9, wherein the first upper section tapers inward toward the middle of the first upper section.
